(19) United States
(12) Patent Application Publication
(10) Pub. No.: US 2009/0317209 A1
(43) Pub. Date: Dec. 24, 2009

(54) Method For Mounting A Screw And A Thread-Armoring Element, And Arrangement For Carrying Out Said Method

(76) Inventors: Klaus Friedrich Grubert, Buckeburg (DE); Torsten Draht, Schloss Holte (DE); Wulf Leitermann, Bad Wimpfen (DE); Francisco Tovar, Bielefeld (DE)

Correspondence Address: SEYFARTH SHAW LLP, 131 S. DEARBORN ST., SUITE 2400, CHICAGO, IL, 60603-5803, US

(21) Appl. No.: 12/440,388

(22) PCT Filed: Sep. 5, 2007
(86) PCT No.: PCT/EP2007/007751

§ 371 Date: May 14, 2009

(30) Foreign Application Priority Data
Sep. 6, 2006 (EP) 06018644.2

(51) Int. Cl. F16B 25/10; F16B 37/12; F16B 11/00

(52) U.S. Cl. 411/387.4; 411/438; 403/265

(57) ABSTRACT

A method for mounting a screw and a thread-armoring element in a receiving thread of a component is described, in which the thread-armoring element is immobilized on the screw and the screw with the thread-armoring element immobilized on it is then screwed into the receiving thread of the component in one single work step. An arrangement comprising a screw and a thread-armoring element immobilized on it for carrying out said method is also described.

### FIELD OF THE INVENTION

The present invention relates to a method for mounting a screw and a thread-armoring element in a receiving thread of a component and an arrangement and a thread-armoring element for carrying out said method.

### BACKGROUND OF THE INVENTION

Conventional thread inserts in the form of a helically coiled wire or a threaded bushing serve to strengthen the receiving thread of components made of materials with a relatively low strength. For this purpose, the thread-armoring element is mounted in the receiving thread, whereupon then the screw can be screwed into the thread-armoring element. The total mounting thus requires two work steps: first the insertion of the thread-armoring element into the receiving thread and then the insertion of the screw into the mounted thread-armoring element, which makes the mounting correspondingly complex.

Two mounting types are common for the insertion of the thread-armoring element. In the case of the one mounting type, the helical wire is provided with a pull-in recess, via which a special tool carries along the helical wire and screws it into the receiving thread, see e.g. U.S. Pat. Nos. 4,563,119, 4,645,398, 4,553,303, etc. In the case of the other mounting type, the helical wire is provided on one end with a diagonally running pull-in pin, via which in turn a special tool carries along the helical wire and hereby screws it into the receiving thread, see e.g. U.S. Pat. Nos. 2,152,681, 2,363,663, etc. The pull-in recess results in a cross-sectional change in the wire, which makes the winding process more difficult. The pull-in pin or tang has the disadvantage that it must be broken and removed after mounting. In each case, a complex and expensive special tool for the insertion of the helical wire into the receiving thread is required.

A thread-armoring element in the form of a helical wire, which is provided with a diametrically running pull-in pin on one end, is known from U.S. Pat. No. 2,150,876 and U.S. Pat. No. 2,745,457. The associated screw is provided with a diametrically running groove on its end facing away from the screw head, into which the pull-in pin of the helical wire is snapped when the wire is mounted on the screw. The screw and the wire mounted on it can thus be inserted into the receiving thread of the component together. This simplifies the mounting process; however, the creation of the groove in the screw and of the pin on the helical wire requires corresponding effort.

A thread-armoring element in the form of a helical wire is known from US 2005/0095083 A1, which is first immobilized on the screw through a frictional connection and then the screw with the thread-armoring element immobilized on it is screwed into the receiving thread of the component in one single work step. The helical wire has an internal and external thread, the form of which is adjusted to the form of the thread of the screw or the receiving thread. The frictional connection is thereby achieved in that the inner and outer diameter of the internal thread of the helical wire is smaller in one end area than the inner and outer diameter of the thread of the screw when the helical wire is unstressed. In accordance with one embodiment, the helical wire has a cylindrical area in front of the diameter-reduced area, which serves as an insertion aid.

### SUMMARY OF THE INVENTION

Further improvement of a method for mounting a screw and a thread-armoring element in a receiving thread of a component should be created through the present invention. The invention also relates to an arrangement and a thread-armoring element for carrying out said method.

Different aspects of the method according to the invention are defined in claims 1, 4, 6, 8, 14. An arrangement for carrying out said method according to the invention is defined in claim 23. Thread-armoring elements according to the invention are defined in claims 24 and 25.

In accordance with a first aspect of the invention (claim 1), the thread-armoring element designed as a helical wire is immobilized both through frictional connection and through an adhesive bond on the screw. This ensures a particularly secure immobilization of the thread-armoring element on the screw.

In accordance with a second aspect of the invention (claim 4), the thread-armoring element is designed in the form of a helical wire such that its radial inner and outer enveloping ends run conically over their entire axial length. This geometrical form of the helical wire has different handling advantages.

In accordance with a third aspect of the invention (claim 6), it is provided that the thread-armoring element designed as a helical wire has a coil-spring area with at least one coil located upstream, the inner diameter of which is reduced with respect to the inner diameter of the coil-spring area, wherein the screw has a pilot tip, which protrudes into the at least one upstream coil during the immobilization of the helical wire.

In accordance with a fourth aspect of the invention (claim 8), at least two diameter-reduced coils, which are a positively connected with each other, are located upstream from a coil-spring area of the thread-armoring element designed as a helical wire. The upstream coils thus have a bushing-like character, which prevents the screw from being moved through the helical wire due to its rigidity. This ensures a particularly secure immobilization of the thread-armoring element on the screw.

In accordance with a fifth aspect of the invention (claim 14), the thread-armoring element designed as a helical wire is immobilized through a positive connection on the screw. In the end area, the wire has at least two coils, which are connected for the formation of a bushing-like area through adhesive bonding with each other. The positive connection between the wire and the screw is achieved through a stop part provided in the end area of the wire, against which the screw hits during immobilization of the thread-armoring element on the screw, whereby the penetration depth of the screw is axially restricted. This also ensures a particularly secure immobilization of the thread-armoring element on the screw.

In the method according to the invention, the thread-armoring element is first immobilized on the screw and then the screw with the thread-armoring element immobilized on it is screwed into the receiving thread in one single work step.

The “final mounting” of the thread-armoring element and of the screw is thus reduced to one single work step, which can be executed by means of conventional screw tools. As long as the thread-armoring element is immobilized on the screw through a frictional connection and/or an adhesive bond, the screw does not need to be provided with a “pull-in groove” as in the initially discussed state of the art. A conventional screw can thus be used. It is also not required that the thread-armoring element is provided with a pull-in pin or tang, which would subsequently need to be broken off.

The “pre-mounting,” i.e. the immobilization of the thread-armoring element on the screw, can be performed for example by the screw manufacturer, whereupon the screw with the thread-armoring element immobilized on it can then be handled as one unit and delivered to the customer (e.g. a car manufacturer). The pre-mounting by the screw manufacturer does not require much effort. However, the time savings by the customer are considerable.

Further advantageous embodiments of the invention are defined in the dependent claims.

### BRIEF DESCRIPTION OF THE DRAWINGS

Exemplary embodiments of the invention are explained in greater detail based on the drawings.

FIGS. 1 through 4 show a perspective view of a screw with a thread-armoring element immobilized on it in different phases of a mounting process;

FIGS. 5 and 6 show perspective views of a screw with a thread-armoring element designed as a helical wire;

FIG. 7 shows a perspective view of a screw with a thread-armoring element designed as a threaded bushing;

FIG. 8 shows an enlarged, partially cut side view of the threaded bushing in FIG. 4;

FIG. 9 shows a screw with a conventional thread-armoring element, which is shown in an axial cut only on the left side of the screw;

FIG. 10 shows a representation corresponding to FIG. 9 with a thread-armoring element designed according to the invention;

FIG. 11 shows an arrangement made up of a screw and an axially cut thread-armoring element according to a further embodiment of the invention;

FIG. 12 shows a view of an arrangement corresponding to FIG. 11 in accordance with another embodiment of the invention;

FIG. 13 shows a view of another embodiment of the invention corresponding to FIG. 11;

FIG. 14 shows a view of another embodiment of the invention corresponding to FIG. 11;

FIG. 15 shows a view of another embodiment of the invention corresponding to FIG. 11.

### DETAILED DESCRIPTION OF A PREFERRED EMBODIMENT OF THE INVENTION

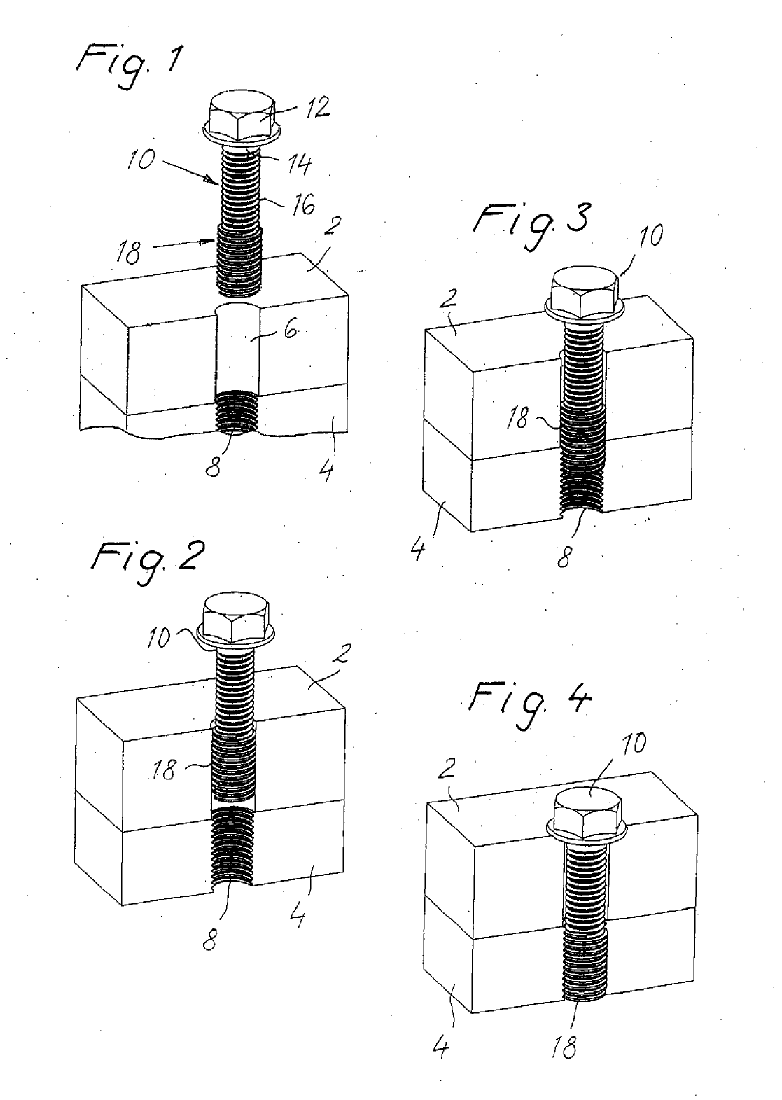

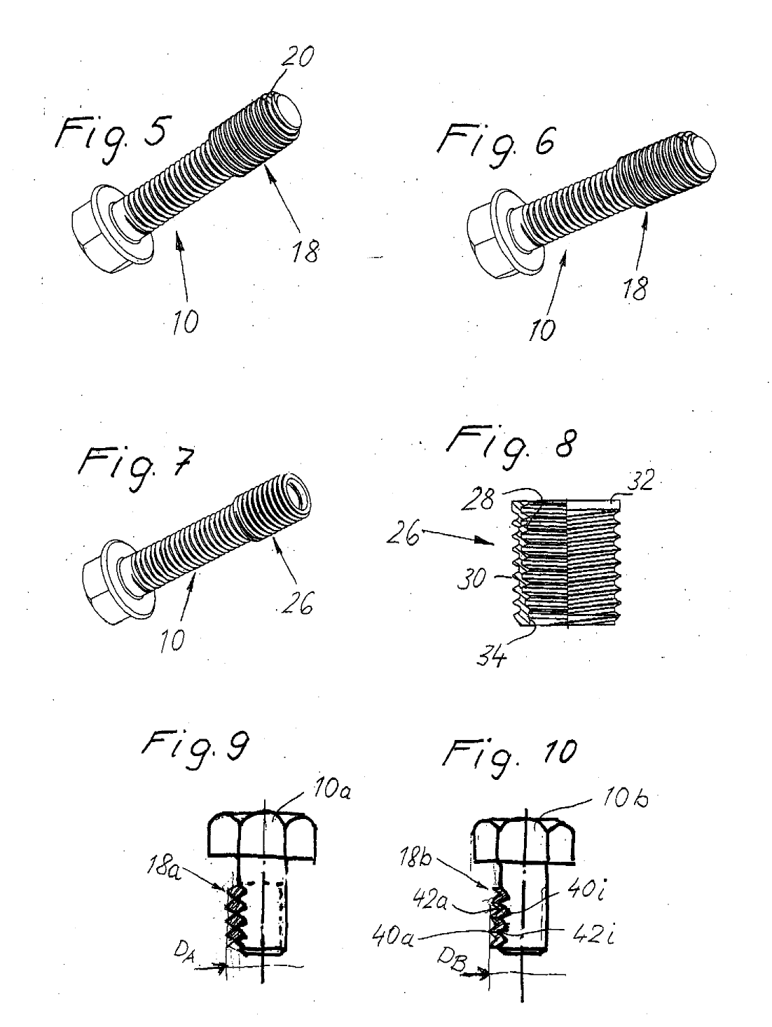

FIGS. 1 through 4 indicate two components 2 and 4 to be connected together, of which the component 2 is provided with a smooth-walled bore hole 6 and the component 4 is provided with a receiving thread 8. A screw 10 is provided to connect the two components 2, 4. The screw 10 is made up of a head 12 and a screw shaft 14 with a thread 16.

In order to strengthen the receiving thread 8, a thread-armoring element 18 in the form of a helically coiled spring wire is provided, the outer form of which is adjusted to the receiving thread 8 and the inner form of which is adjusted to the thread 16 of the screw 10.

As shown in FIGS. 5 and 6, the helical wire 18 is made up of a simple spiral, which neither has a pull-in pin nor a pull-in recess. The spiral is made of a material, which gives the spiral elastically resilient properties. This material can be different from the material of the screw and/or the receiving thread.

In the case of the mounting process to be described, the thread-armoring element 18 is first applied to the thread 16 of the screw 10. As will be explained in greater detail, the thread-armoring element 18 is hereby immobilized on the screw 10, so that the thread-armoring element is held in an undetachable manner on the screw 10.

The screw 10 with the thread-armoring element 18 immobilized on it is then screwed through the bore hole 6 of the component 2 into receiving element 8 of the component 4 by means of a conventional screw tool (not shown). The pretensioning force required for a high-strength screw connection can hereby be created by tightening the screw 10. Special tools and associated complex mounting processes are not required.

In the case of the exemplary embodiments in FIGS. 5 and 6, the thread-armoring element 18 is immobilized on the screw 10 through frictional connection and adhesive bonding. The frictional connection is preferably achieved in that the thread-armoring element 18 has on its one end an end section 20 with one to two coils, the inner diameter of which is smaller than the thread diameter of the screw 10. A sort of coil-spring effect is thus created through which the thread-armoring element 18 is immobilized on the screw 10 and screwed into the receiving thread 8 by the screw during the mounting.

The diameter-reduced end section 20 of the helical coil 18 preferably extends over 360° to 720°, even though it can also be selected to be smaller or larger. The diameter reduction of the end section 20 is large enough to create a frictional connection with the thread of the screw 10, which is larger than the torque required to screw the thread-armoring element into the receiving thread. Outside of the end section 20, the helical wire 18 in the uninstalled state has an outer diameter that is somewhat larger than the inner diameter of the receiving thread 8 in order to ensure a tight fit of the thread-armoring element after installation.

The adhesive bond between the thread-armoring element 18 and the screw 10 can be achieved for example through the application of an adhesive bonding agent, in particular wax or glue between the thread-armoring element and the screw, which preferably takes place through dipping into the bonding agent (wax, glue, etc.). A corresponding positive connection between thread-armoring element and screw is indicated in FIG. 6. Another possibility for a positive connection is a welded or soldered connection between the thread-armoring element 18 and the screw 10, wherein this connection can be provided for example in the area of reference number 20 in FIG. 5.

Concerning the mounting of the screw with the thread-armoring element immobilized on it, two cases can be differentiated:

In one case, the thread-armoring element is also turned by the screw not only during the screwing of the arrangement into the receiving thread 8, but during the entire tightening process. The application of the pretensioning force for the screw connection then takes place with thread friction between the external thread of the thread-armoring element and the receiving thread 8 in component 4. This type of mounting takes place for example in exemplary embodiments in which the thread-armoring element 18 is immobilized on the screw 10 through welding or soldering.

In the other case, the immobilization between the thread-armoring element 18 and the screw is released during the course of the tightening process due to the increasing load on the connection. For example, the frictional or positive connection between the thread-armoring element 18 and the screw 10 “breaks” at e.g. one fourth of the nominal tightening torque of the screw connection so that the remaining tightening process takes place with thread friction between the thread-armoring element 18 and the screw 10 and not between the receiving thread and the thread-armoring element. Since the “lifting arm” of the thread friction is smaller than in the former case, an even and comparatively low thread friction, i.e. an optimal thread friction, is achieved.

If the frictional and adhesive connection between the thread-armoring element 18 and the screw 10 only breaks during the removal of the screw 10, then this at least makes it possible to mount any other screw during remounting.

In the case of the exemplary embodiment in FIGS. 7 and 8, which does not belong to the invention, the thread-armoring element is made of a threaded bushing 26. The threaded bushing 26 is provided with an internal thread 28 and an external thread 30, which are offset with respect to each other by a half thread pitch so that the threaded bushing has a correspondingly low wall thickness. However, this type of thread offset between the internal thread and external thread is not absolutely required. However, a thin-walled threaded bushing of a different geometrical shape can be used.

The threaded bushing 26 has a circumferential collar 32 on its one axial end. The internal thread 28 has at least one incompletely designed coil 34 on the other axial end of the threaded bushing 26. When the threaded bushing 26 is thus applied to the screw 10, the threaded bushing 26 is immobilized on the screw 10 through the incompletely designed coil(s) 34 of the internal thread 28. The mounting can then take place in the same manner as described based on FIGS. 1 through 4.

If the axial length of the screw shaft 14 of the screw 10 is larger than the joint thickness of the components 2 and 4, then the collar 32 of the threaded bushing 26 piles up on the receiving thread 8 of the component 4 during mounting. The thread 16 of the screw 10 then passes through the incompletely shaped coil(s) 34 of the threaded bushing until the screw head 12 fits on component 2.

Instead of through frictional connection or in addition to the frictional connection, the threaded bushing 26 on the screw 1 can be immobilized on the screw 10 through an adhesive bond, e.g. through immersion in an adhesive bonding agent such as wax, glue or through welding or soldering.

The threaded bushing 26 can also be provided with an anti-reverse device (not shown) so that the threaded bushing remains in the receiving thread 8 during the removal of the screw 10. The anti-reverse device can take place through a positive connection, for example through a knurl contour on the collar 32 or a barb contour (undercuts in the circumferential direction) on the external thread 30. However, the anti-reverse device can also take place through frictional connection and/or adhesive bonding, e.g. a glue coating on the external thread 30 of threaded bushing 32.

A corresponding anti-reverse device (not shown) can also be provided on the helical wire 18, wherein the anti-reverse device can take place through positive connection and/or frictional connection and/or adhesive bonding. In order to achieve a positive connection, the outer perimeter of the helical wire is advantageously provided with a knurl contour or a barb contour (undercuts).

If the material of the thread-armoring element has a considerably greater hardness than that of the receiving thread, then the thread-armoring element can be designed as a thread-tapping element. In this case, the component is provided with a smooth receiving bore hole, into which the thread-armoring element then cuts or carves a thread when it is screwed into the receiving bore hole together with the screw.

Before the screw 10 with the thread-armoring element immobilized on it is screwed into the receiving thread 8 of the component 4, the screw 10 and the thread-armoring element 18 or 26 can be connected with the second component 2 such that thread-armoring element serves as a securing device for the screw on the component 4. This can be achieved in that the screw 10 is first inserted through the bore hole 6 of the component 2 and then the thread-armoring element 18 or 26 is immobilized in the described manner on the screw 10. Another possibility is that the thread-armoring element 18 or 26 is immobilized on the screw 10 in the described manner, before both are moved through the bore hole 6. However, this requires that the diameter of the thread-armoring element is somewhat reducible on the screw so that the screw with the thread-armoring element can be moved through the bore hole 6, whereupon the thread-armoring element 18 then expands slightly so that the screw is then held in the bore hole 6 of the component 2 by the thread-armoring element. In any case, this makes it possible to in a sense “pre-confection” the component with the screw or with several screws and the associated thread-armoring elements in order to then accordingly simplify the screwing of component 2 onto component 4.

FIG. 9 shows a screw 10a with a conventional thread-armoring element 18a in the form of a spring wire helically coiled with respect to a central axis X, which is only shown on the left side of the screw 10a for the sake of simplicity. The thread-armoring element 18a has a diamond-shaped cross-section in axial planes (for example drawing plane) so that a zigzag progression results for the inner and outer contour of the thread-armoring element 18a. As can be seen in FIG. 9, the “peaks” of the inner and outer contour lie in joint radial planes, and the valleys of the inner and outer contour also lie in joint radial planes offset by a half thread pitch.

FIG. 10 shows an arrangement of a screw 10B and a thread-armoring element 18b according to FIG. 9 in the form of a helically coiled spring wire, the cross-section of which is however modified according to the invention.

The thread-armoring element 18b also has a zigzag running inner and outer contour. However, in contrast to the conventional thread-armoring element 18a in FIG. 9, the cross-section of the thread-armoring element 18b is designed such that the peaks 40i of the inner contour and the valleys 42a of the outer contour lie in joint radial planes and the valleys 42i of the inner contour and the peaks 40a of the outer contour also lie in joint radial planes. This thus results in a gabled or arrowhead-like cross-section of the thread-armoring element 18b in axial planes.

As a result of this cross-sectional shape, the outer diameter D_{B} of the thread-armoring element 18b is considerably smaller than the outer diameter D_{A} of the thread-armoring element 18a. This enables the use of a receiving thread with a smaller diameter or a screw with a larger diameter.

Even though the inner and outer contour of the thread-armoring element 18b has a zigzag progression, another wave-like progression of the inner and outer contour is also possible. Thus, the peaks and valleys of the wave-like inner and outer contour could be rounded.

In the case of the exemplary embodiment shown in FIG. 10, the individual coils of the thread-armoring element 18b are divided into radial planes, in which the valleys 42i and peaks 40a of the inner and outer contour lie. Instead, the division could be provided offset by a half thread pitch so that the division planes then run through the peaks 40i of the inner contour and the valleys 42a of the outer contour.

As already mentioned, in the case of the exemplary embodiment in FIGS. 5 and 6, the thread-armoring element 18 is immobilized on the screw 10 by both frictional connection and through adhesive bonding. The adhesive bonding is preferably provided only in the area of the frictional connection, whereby the effort for the adhesive bonding is reduced. The joint use of a friction connection and adhesive bonding has in particular the advantage of a particularly secure immobilization of the thread-armoring element on the screw.

FIGS. 11 through 15 show further exemplary embodiments of arrangements comprising a screw with a thread-armoring element immobilized on it, which is designed as a helical wire in these exemplary embodiments.

In the case of the exemplary embodiment in FIG. 11, the helical wire 18c has an (imaginary) inner and outer enveloping end E, each of which are designed as a cone over their entire axial length. The diameters of the wire 18c are hereby selected such that the smallest inner diameter of the internal thread of the wire 18c is smaller and the largest inner diameter of the internal thread of the wire 18c is larger than the inner diameter of the thread 16 of the screw 10. As can be seen in the figures for all exemplary embodiments shown, a screw with a cylindrical shaft is assumed.

Based on the described diameter dimensioning of the wire 18c, one or more coils on the tapered end of the wire 18c form a coil-spring area, through which the wire 18c is immobilized in a frictional manner on the screw 10. As in the exemplary embodiments described above, it is generally possible that the helical wire 18c is also immobilized on the screw through an adhesive connection, wherein the adhesive connection is then preferably only provided in the coil-spring area.

Depending on the application, the cone angle β is selected, wherein it preferably lies in the range of 1 to 5°, for example on the order of magnitude of 2 to 3°.

In the case of thread-armoring elements in the form of helical wires, which are provided with a coil-spring area, the helical wire must receive a certain alignment during mounting in order to be able to be inserted into the receiving thread (see FIGS. 1 through 4). If the helical wire as in FIGS. 5 and 6 is only provided with one or a few diameter-reduced coils, while the remaining part of the wire is designed cylindrically, then it is not generally simple to detect the desired alignment of the wire. In contrast, if the helical wire 18c is designed overall conically or tapered as in the exemplary embodiment in FIG. 11, the desired alignment of the wire is much easier to detect. Thus, if the helical wires are delivered as bulk goods, the conical form of the wire facilitates its alignment and thus its handling, which facilitates the overall mounting process.

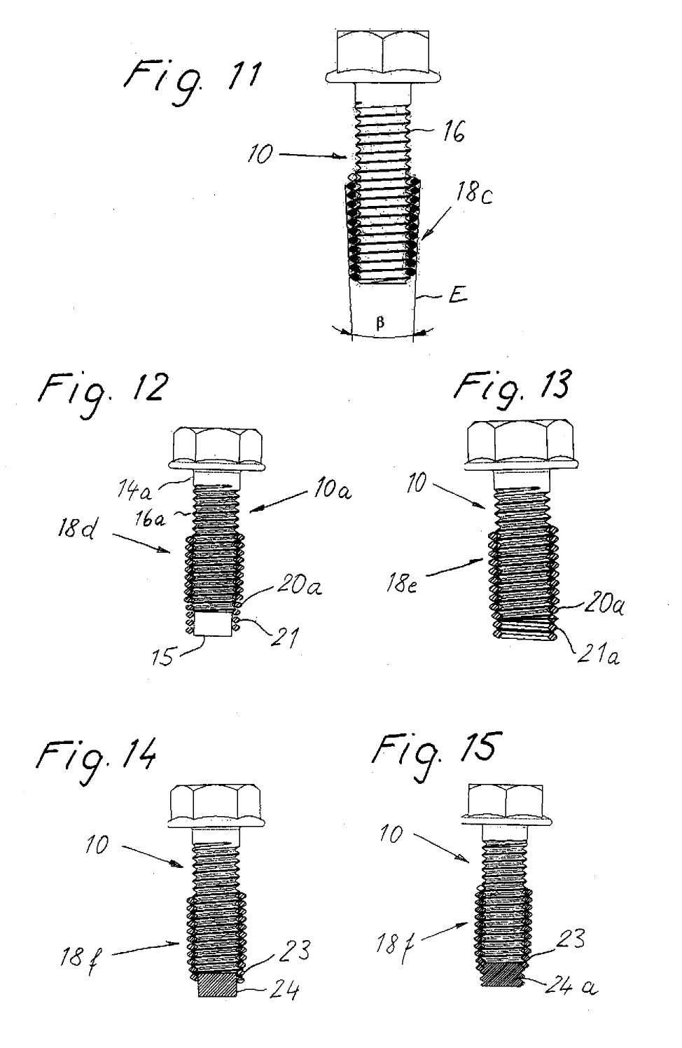

In the case of the exemplary embodiment in FIG. 12, the fundamental structure of the helical wire 18d matches the thread-armoring element 18 in FIGS. 5 and 6. That is, the helical wire 18d has a cylindrical area and a connecting coil-spring area 20a, in which the outer diameter of the internal thread of the helical wire 18d is smaller than the outer diameter of the thread 16a of the screw 10a.

Different from the exemplary embodiment in FIGS. 5 and 6 is the fact that at least one and preferably several (e.g. two or three) coils are located upstream from the coil-spring area 20a, the inner diameter of which is reduced with respect to the inner diameter of the coil-spring area 20a. The diameter reduction is so large that the upstream coil or the upstream coils 21 can serve on one hand as an insertion aid and/or as a centering aid and on the other hand a penetration of the screw thread into this upstream area is prevented. In other words, the diameter reduction is considerably larger than the diameter reduction that is required to achieve the coil-spring effect in the coil-spring area 20a.

As can be seen in FIG. 12, the screw 10a is provided with a pilot tip 15 on the end of its shaft 14a. In the exemplary embodiment shown, the pilot tip 15 is designed cylindrically; however, it could in general have a different shape. In any case, the pilot tip 15 penetrates in the area of the upstream coil(s) 21 during the immobilization of the helical wire 18d on the screw 10a. The helical wire 18d is hereby stabilized in the upstream area.

This embodiment has the advantage that the screwing in of the arrangement made up of the screw and the thread-armoring element into the receiving thread (FIG. 1 through 4) is facilitated. In particular, the risk that the receiving thread can be damaged while this arrangement is being screwed in is hereby reduced; this risk being particularly present in the case of soft materials like aluminum. The overall mounting process is thus made easier and more secure.

In the case of the exemplary embodiment in FIG. 13, the fundamental structure of the arrangement corresponds with that of FIG. 12. Thus, several (e.g. two or three) diameter-reduced coils 21 a are also located upstream from the coil-spring area 20a in the exemplary embodiment in FIG. 13.

However, the difference is that for one a conventional screw 10 can be used without a pilot tip and on the other hand the upstream coils 21a are connected together via an adhesive bond. The adhesive bond gives the upstream coils 21a a sort of bushing character. This results in the fact that the screw 10 can only penetrate the helical wire 18e up to the coil-spring area 20a but cannot pass through the upstream coils 21a. The helical wire 18e is thus immobilized on the screw 10 with a high level of security so that it is in a sense turned along in a “positively connected” manner during the screwing of the screw and wire arrangement into the receiving thread.

This also reduces the risk of damage to the receiving thread so that the mounting process can be executed easily and reliably.

The adhesive bond of the interconnected upstream coils 21a can be achieved for example through welding or soldering or gluing. It would also generally be possible in the case of this exemplary embodiment—as well as in the case of the exemplary embodiment in FIG. 12—to also immobilize the helical wire 18d or 18e on the screw 10a or 10 through an adhesive bond, which is however generally unnecessary.

A conventional screw 10 can be used in the case of the exemplary embodiments in FIGS. 14 and 15—as in the exemplary embodiments in FIGS. 5, 6, 11 and 13. The design of the thread-armoring element in the form of a helical wire 18f and the type of immobilization on the screw 10 are however generally different from those in the previous exemplary embodiments:

namely, the immobilization of the wire 16f on the screw 10 does not take place through frictional connection or adhesive bonding, but rather through positive connection. For this purpose, the helical wire 18f has several (e.g. two or three) coils, which are interconnected for the formation of a bushing-like area through an adhesive connection, on its bottom end (in FIGS. 14, 15). Moreover, a stop part 24 or 24a, against which the screw 10 hits during the immobilization of the helical wire 18f so that the screw cannot be screwed further into the helical wire, is permanently connected with the helical wire 18f in this area.

As can be seen in FIGS. 14 and 15, the stop part 24 or 24a protrudes axially from the bushing-like area of the adhesively connected coils 23. The stop part can thus serve as a location and/or centering aid during the screwing of the arrangement into the receiving thread.

In the case of the exemplary embodiments in FIGS. 14 and 15, the stop part 24 or 24a consists of a base plate, which closes the inside of the bushing-like area (coils 23) of the helical wire 18f. However, instead of a base plate, the stop part can also be designed in any other manner as long as the penetration depth of the screw in the helical wire is axially restricted. Thus, the stop part could for example consist of a transverse running latch or suchlike.

As already mentioned, a coil-spring area of the helical wire is not required in the case of the exemplary embodiments in FIGS. 14 and 15 even though it could be provided. However, the coils 23, which are connected adhesively, should preferably taper in the direction of the stop part 24 or 24a in order to facilitate the screwing of the arrangement into the receiving thread.

In the case of the exemplary embodiment in FIG. 14, the stop part 24 is designed as a cylindrical part with a smooth outer surface so that it serves as a centering aid during the screwing of the arrangement into the receiving thread. In the case of the exemplary embodiment in FIG. 15, the stop part 24a is provided with a thread on its outer perimeter, which serves as a location aid during the screwing of the arrangement into the receiving thread.

In both cases, the insertion of the arrangement made up of the screw and the helical wire into the receiving thread is hereby made easier and more secure, which in turn reduces the risk of damage to the receiving thread.

As was already mentioned and as can be seen in the drawings of the described exemplary embodiments, the helical wire has respectively an internal thread that corresponds to the thread of the screw and an external thread that corresponds to the thread of the receiving thread. The number of thread pitches of the screw hereby corresponds to the number of thread pitches of the receiving thread, wherein the helical wire respectively essentially completely fills the thread grooves of the screw and the thread grooves of the receiving thread in the concerned area.

In the case of the exemplary embodiments in FIGS. 11 through 15, the mounting of the arrangement made up of the screw and wire takes place in the receiving thread essentially in the same manner as was described for FIGS. 5 and 6. In short, the helical wire is first immobilized on the screw and then the screw with the thread-armoring element immobilized on it is screwed into the receiving thread in a single work step.

We claim:

1. A method for mounting a screw and a thread-armoring element in a receiving thread of a component, in which the thread-armoring element is first immobilized on the screw through frictional connection and adhesive bonding and then the screw with the thread-armoring element immobilized on it is screwed into the receiving thread of the component in one single work step, wherein the thread-armoring element is a helical wire, the inner form of which is fitted to the thread of the screw and the outer form of which is fitted to the receiving thread.

2. The method according to claim 1, characterized in that the frictional connection is achieved in that the outer diameter of the internal thread of the helical wire in one end section is smaller than the outer diameter of the thread of the screw when the helical wire is unloaded.

3. The method according to claim 1, characterized in that the adhesive bond is only provided in the area of the end section of the helical wire.

4. The method according to claim 1, characterized in that the immobilization of the thread-armoring element on the screw is designed such that the thread-armoring element is also turned during the entire tightening process.

5. The method according to claim 1, characterized in that the immobilization of the thread-armoring element on the screw is designed such that the immobilization is released during the tightening of the screw and the development of the pretensioning force.

6. The method according to claim 1, characterized in that an adhesive bond between the thread-armoring element and the screw is achieved through an adhesive bonding agent or welding or soldering.

7. A method according to claim 1, characterized in that the thread-armoring element is designed as a thread-tapping element.

8. A method according to claim 1, in which the screw and the thread-armoring element are used to screw a second component onto the first component provided with the receiving thread, characterized in that the screw is inserted through a bore hole of the second component and the thread-armoring element immobilized on the screw is used as a securing device for the screw so that the second component with screw and thread-armoring element can be handled as a unit before mounting on the first component.

9. A method for mounting a screw and a thread-armoring element in a receiving thread of a component, in which the thread-armoring element is first immobilized on the screw through frictional connection and/or adhesive bonding and then the screw with the thread-armoring element immobilized on it is screwed into the receiving thread of the component in one single work step, wherein the thread-armoring element is a helical wire, the radial inner and outer enveloping end of which is designed as a cone over its entire axial length.

10. The method according to claim 9, characterized in that the cone angle of the radial inner and outer enveloping ends lies in the range of 1 to 5°.

11. The method according to claim 9, characterized in that the immobilization of the thread-armoring element on the screw is designed such that the thread-armoring element is also turned during the entire tightening process.

12. The method according to claim 9, characterized in that the immobilization of the thread-armoring element on the screw is designed such that the immobilization is released during the tightening of the screw and the development of the pretensioning force.

13. The method according to claim 9, characterized in that an adhesive bond between the thread-armoring element and the screw is achieved through an adhesive bonding agent or welding or soldering.

14. A method according to claim 9, characterized in that the thread-armoring element is designed as a thread-tapping element.

15. A method according to claim 9, in which the screw and the thread-armoring element are used to screw a second component onto the first component provided with the receiving thread, characterized in that the screw is inserted through a bore hole of the second component and the thread-armoring element immobilized on the screw is used as a securing device for the screw so that the second component with screw and thread-armoring element can be handled as a unit before mounting on the first component.

16. A method for mounting a screw and a thread-armoring element in a receiving thread of a component, in which the thread-armoring element is first immobilized on the screw through frictional connection and then the screw with the thread-armoring element immobilized on it is screwed into the receiving thread of the component in one single work step, wherein the thread-armoring element is a helical wire, the inner form of which is fitted to the thread of the screw and the outer form of which is fitted to the receiving thread, and the frictional connection is achieved in that the outer diameter of the internal thread of the helical wire in a coil-spring area is smaller than the outer diameter of the thread of the screw when the helical wire is unloaded, wherein at least one coil is also located upstream from the coil-spring area of the helical wire, the inner diameter of which is reduced with respect to the inner diameter of the coil-spring area in order to serve as an insertion and/or centering aid, and the screw has a pilot tip, which protrudes into the at least one upstream coil during the immobilization of the helical wire on the screw in order to stabilize it.

17. The method according to claim 16, characterized in that the pilot tip of the screw is designed cylindrically.

18. The method according to claim 16, characterized in that the immobilization of the thread-armoring element on the screw is designed such that the thread-armoring element is also turned during the entire tightening process.

19. The method according to claim 16, characterized in that the immobilization of the thread-armoring element on the screw is designed such that the immobilization is released during the tightening of the screw and the development of the pretensioning force.

20. The method according to claim 16, characterized in that an adhesive bond between the thread-armoring element and the screw is achieved through an adhesive bonding agent or welding or soldering.

21. A method according to claim 16, characterized in that the thread-armoring element is designed as a thread-tapping element.

22. A method according to claim 16, in which the screw and the thread-armoring element are used to screw a second component onto the first component provided with the receiving thread, characterized in that the screw is inserted through a bore hole of the second component and the thread-armoring element immobilized on the screw is used as a securing device for the screw so that the second component with screw and thread-armoring element can be handled as a unit before mounting on the first component.

23. A method for mounting a screw and a thread-armoring element in a receiving thread of a component, in which the thread-armoring element is first immobilized on the screw through frictional connection and then the screw with the thread-armoring element immobilized on it is screwed into the receiving thread of the component in one single work step, wherein the thread-armoring element is a helical wire, the inner form of which is fitted to the thread of the screw and the outer form of which is fitted to the receiving thread, and the frictional connection is achieved in that the outer diameter of the internal thread of the helical wire in a coil-spring area is smaller than the outer diameter of the thread of the screw when the helical wire is unloaded, and wherein at least two diameter-reduced coils, which are adhesively interconnected, are also located upstream from the coil-spring area of the helical wire.

24. The method according to claim 23, characterized in that the adhesive connection of the interconnected upstream coils can be achieved through welding or soldering or gluing.

25. The method according to claim 23, characterized in that the radial inner and outer enveloping ends of the upstream coils are designed cylindrically.

26. The method according to claim 23, characterized in that the immobilization of the thread-armoring element on the screw is designed such that the thread-armoring element is also turned during the entire tightening process.

27. The method according to claim 23, characterized in that the immobilization of the thread-armoring element on the screw is designed such that the immobilization is released during the tightening of the screw and the development of the pretensioning force.

28. The method according to claim 23, characterized in that an adhesive bond between the thread-armoring element and the screw is achieved through an adhesive bonding agent or welding or soldering.

29. A method for mounting a screw and a thread-armoring element in a receiving thread of a component, in which the thread-armoring element is first immobilized on the screw through frictional connection and then the screw with the thread-armoring element immobilized on it is screwed into the receiving thread of the component in one single work step, wherein the thread-armoring element is a helical wire, which has at least two coils in an end area, which are adhesively interconnected for the formation of a bushing-like area, and the positive connection is achieved through a stop part provided in the end area of the helical wire, against which the screw hits during immobilization of the helical wire on the screw, in order to axially restrict the penetration depth of the screw.

30. The method according to claim 29, characterized in that the stop part axially protrudes from the bushing-like area of the helical wire in order to serve as a location and/or centering aid.

31. The method according to claim 29, characterized in that the stop part comprises a base plate, which closes the bushing-like area of the helical wire on the inside.

32. The method according to claim 31, characterized in that the stop part designed as a base plate is designed smooth in order to serve as a centering aid.

33. The method according to claim 31, characterized in that the stop part designed as a base plate has a thread on its outer perimeter, which serves as a location aid.

34. The method according to claim 29, characterized in that the bushing-like area of the helical wire tapers in the direction of the stop part in order to be able to be screwed into the receiving thread of the component.

35. A method according to claim 29, characterized in that the thread-armoring element is designed as a thread-tapping element.

36. A method according to claim 29, in which the screw and the thread-armoring element are used to screw a second component onto the first component provided with the receiving thread, characterized in that the screw is inserted through a bore hole of the second component and the thread-armoring element immobilized on the screw is used as a securing device for the screw so that the second component with screw and thread-armoring element can be handled as a unit before mounting on the first component.

37. An arrangement comprising a screw and a thread-armoring element immobilized on it for carrying out the method for mounting the screw and the thread-armoring element in a receiving thread of a component.

38. A thread-armoring element for an arrangement according to claim 37.

39. A thread-armoring element, in particular for a method and an arrangement for mounting a screw and a thread-armoring element in a receiving thread of a component in the form of a spring wire helically coiled with respect to the central axis, the outer form of which is fitted to a receiving thread and the inner form of which is fitted to a screw, wherein the helically coiled spring wire in axial planes has an inner and outer contour, each of which has a wavy form with peaks and valleys, wherein the peaks of the inner contour and the valleys of the outer contour lie in joint radial planes and the valleys of the inner contour and the peaks of the outer contour lie in joint radial planes.

40. The thread-armoring element according to claim 39, characterized in that the wave form of the inner and outer contour are both zigzagged.
